(19) United States
(12) Patent Application Publication
(10) Pub. No.: US 2010/0321302 A1
(43) Pub. Date: Dec. 23, 2010

(54) SYSTEM AND METHOD FOR NON-ROMAN TEXT INPUT

(75) Inventors: Parul Nanda, Gurgaon (IN); Vadim Fux, Waterloo (CA); Xiaoting Sun, Waterloo (CA)

Correspondence Address: RIM/FINNEGAN, 901 New York Avenue NW, Washington, DC, 20001, US

(73) Assignee: RESEARCH IN MOTION LIMITED, Waterloo, ON (CA)

(21) Appl. No.: 12/616,182

(22) Filed: Nov. 11, 2009

Related U.S. Application Data
(60) Provisional application No. 61/218,503, filed on Jun. 19, 2009.

(51) Int. Cl. G06F 3/02; G06F 3/048

(52) U.S. Cl. 345/171; 715/773

(57) ABSTRACT

An electronic device for non-Roman text input, the device comprising: a non-Roman text input module resident in the memory for execution by the microprocessor, the non-Roman text input module being configured to: provide a non-Roman text input interface for display on the output device, the interface being adapted for non-Roman text input in a first language; receive a signal representing a non-Roman text input in response to an input using the interface; determine a non-Roman character corresponding to the non-Roman text input, the non-Roman character being determined according to one or more rules for determining a compound non-Roman character based on the non-Roman text input in combination with a preceding input; and transmit a signal representing the determined non-Roman character for display on the output device.

### TECHNICAL FIELD

The present disclosure relates generally to electronic devices including touch screen display devices having virtual keyboards. In particular, the present disclosure relates to systems and methods for non-Roman text input, such as Korean text input, in such devices.

### BACKGROUND

Electronic devices, including portable electronic devices, have gained widespread use and can provide a variety of functions including, for example, telephonic, electronic messaging and other personal information manager (PIM) application functions. Portable electronic devices can include several types of devices including mobile stations such as simple cellular telephones, smart telephones, wireless PDAs, and laptop computers with wireless 802.11 or Bluetooth capabilities. These devices run on a wide variety of networks from data-only networks such as Mobitex and DataTAC to complex voice and data networks such as GSM/GPRS, CDMA, EDGE, UMTS and CDMA2000 networks.

Such handheld devices are often used by people that speak multiple languages. Many languages, including the English language, use Roman characters (sometimes also referred to as Latin characters), and thus when a user wishes to input text into a handheld electronic device in such a language, a keyboard including Roman characters, such as a standard QWERTY keyboard, provided as part of the device may be used. However, some languages employ, either partially or entirely, a set of non-Roman characters. One such language is the Korean language. In particular, the Korean alphabet employs non-Roman characters including consonants, vowels, and double consonants. It is desirable to provide an interface for inputting such non-Roman characters. It is further desirable to provide this interface while decreasing the amount of repetitive input or selection required for input of Korean characters.

### BRIEF DESCRIPTION OF THE DRAWINGS

Example embodiments of the present disclosure will now be described, by way of example only, with reference to the attached Figures, wherein:

FIG. 1 is a block diagram of an electronic device suitable for non-Roman text input according to an example;

FIG. 2A is a front view of an example electronic device suitable for text input shown in a portrait orientation;

FIG. 2B shows a cutaway view of an example touch screen display of the portable electronic device of FIG. 1;

FIG. 3 is a simplified sectional side view of the electronic device of FIG. 2A (not to scale), with a switch shown in a rest position;

FIG. 4 is a block diagram of the contents of a memory of the electronic device of FIG. 2A;

FIG. 5A is an example interface suitable for non-Roman text input according to an example;

FIG. 5B is another example interface suitable for non-Roman text input according to another example;

FIG. 6 is an example of input rules for non-Roman text input according to an example;

FIG. 7 is a flowchart illustrating a method for non-Roman text input according to an example;

FIG. 8 is a chart illustrating unicodes for an example set of non-Roman text input; and

FIG. 9 is another example interface suitable for non-Roman text input according to another example.

### DETAILED DESCRIPTION

In some aspects, the present disclosure provides an electronic device for non-Roman text input, the device comprising: a microprocessor for controlling the operation of the wireless device; an input device coupled to the microprocessor for accepting an input; an output device coupled to the microprocessor for communicating an output; and a memory coupled to the microprocessor; the wireless device including a non-Roman text input module resident in the memory for execution by the microprocessor, the non-Roman text input module being configured to: provide a non-Roman text input interface for display on the output device, the interface being adapted for non-Roman text input in a first language; receive a signal representing a non-Roman text input in response to an input using the interface; determine a non-Roman character corresponding to the non-Roman text input, the non-Roman character being determined according to one or more rules for determining a compound non-Roman character based on the non-Roman text input in combination with a preceding input; and transmit a signal representing the determined non-Roman character for display on the output device.

In some aspects, there is also provided a method and a machine readable medium for non-Roman text input.

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. A person skilled in the art would understand that variations and modifications, both those currently known and those that may be later developed, are possible within the scope of the disclosure. Also, the description is not to be considered as limiting the scope of the example embodiments described herein.

The example embodiments described herein generally relate to an electronic device including a touch screen display. Such electronic devices may in particular be portable electronic devices, including communication devices. Examples of portable electronic devices include mobile, or handheld, wireless communication devices such as pagers, cellular phones, cellular smart-phones, wireless organizers, personal digital assistants, wirelessly enabled notebook computers and the like.

The electronic device may be a two-way communication device with advanced data communication capabilities including the capability to communicate with other electronic devices or computer systems through a network of transceiver stations. The electronic device may also have the capability to allow voice communication. Depending on the functionality provided by the electronic device, it may be referred to as a data messaging device, a two-way pager, a cellular telephone with data messaging capabilities, a wireless Internet appliance, or a data communication device (with or without telephony capabilities). The electronic device may also be a portable device without wireless communication capabilities as a handheld electronic game device, digital photograph album, digital camera and the like.

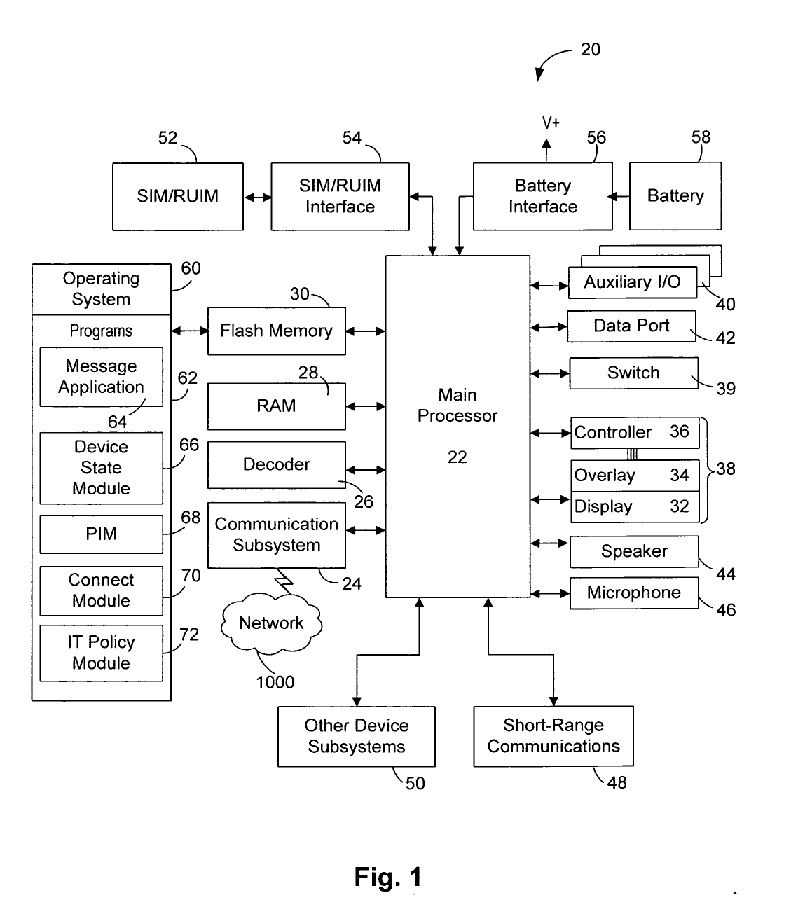

Referring first to FIG. 1, there is shown therein a block diagram of an example embodiment of an electronic device 20. The electronic device 20 includes a number of components such as the main processor 22 that controls the overall operation of the electronic device 20. Communication functions, including data and voice communications, are performed through a communication subsystem 24. Data received by the electronic device 20 can be decompressed and decrypted by a decoder 26, operating according to any suitable decompression techniques (e.g. YK decompression, and other known techniques) and encryption techniques (e.g. using an encryption technique such as Data Encryption Standard (DES), Triple DES, or Advanced Encryption Standard (AES)). The communication subsystem 24 may receive messages from and send messages to a wireless network 1000. In this example embodiment of the electronic device 20, the communication subsystem 24 may be configured in accordance with the Global System for Mobile Communication (GSM) and General Packet Radio Services (GPRS) standards. The GSM/GPRS wireless network is used worldwide. New standards such as Enhanced Data GSM Environment (EDGE) and Universal Mobile Telecommunications Service (UMTS) are believed to have similarities to the network behavior described herein, and it will also be understood by persons skilled in the art that the example embodiments described herein may use any other suitable standards that are developed in the future. The wireless link connecting the communication subsystem 24 with the wireless network 1000 may represent one or more different Radio Frequency (RF) channels, operating according to defined protocols specified for GSM/GPRS communications. With newer network protocols, these channels may be capable of supporting both circuit switched voice communications and packet switched data communications.

Although the wireless network 1000 associated with the electronic device 20 may be a GSM/GPRS wireless network in one example implementation, other wireless networks may also be associated with the electronic device 20 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA1000 networks, GSM/GPRS networks (as mentioned above), and future third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems. The main processor 22 may also interact with additional subsystems such as a Random Access Memory (RAM) 28, a flash memory 30, a display 32 with a touch-sensitive overlay 34 connected to an electronic controller 36 that together make up a touch screen display 38, a switch 39, an auxiliary input/output (I/O) subsystem 40, a data port 42, a speaker 44, a microphone 46, short-range communications 48 and other device subsystems 50. The touch-sensitive overlay 34 and the electronic controller 36 provide a touch-sensitive input device and the main processor 22 may interact with the touch-sensitive overlay 34 via the electronic controller 36.

Some of the subsystems of the electronic device 20 may perform communication-related functions, whereas other subsystems may provide “resident” or on-device functions. By way of example, the display 32 and the touch-sensitive overlay 34 may be used for both communication-related functions, such as entering a text message for transmission over the network 1000, and device-resident functions such as a calculator or task list.

The electronic device 20 can send and receive communication signals over the wireless network 1000 after network registration or activation procedures have been completed. Network access may be associated with a subscriber or user of the electronic device 20. To identify a subscriber according to the present example embodiment, the electronic device 20 may use a SIM/RUIM card 52 (i.e. Subscriber Identity Module or a Removable User Identity Module) inserted into a SIM/RUIM interface 54 for communication with a network such as the network 1000. The SIM/RUIM card 52 is one type of a conventional “smart card” that can be used to identify a subscriber of the electronic device 20 and to personalize the electronic device 20, among other things. In an example embodiment the electronic device 20 may not be fully operational for communication with the wireless network 1000 without the SIM/RUIM card 52. By inserting the SIM/RUIM card 52 into the SIM/RUIM interface 54, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM/RUIM card 52 may include a processor and memory for storing information. Once the SIM/RUIM card 52 is inserted into the SIM/RUIM interface 54, it may be coupled to the processor 22. In order to identify the subscriber, the SIM/RUIM card 52 can include some user parameters such as an International Mobile Subscriber Identity (IMSI). An advantage of using the SIM/RUIM card 52 is that a subscriber is not necessarily bound by any single physical electronic device. The SIM/RUIM card 52 may store additional subscriber information for an electronic device as well, including datebook (or calendar) information and recent call information. Alternatively, user identification information can also be programmed into the flash memory 30.

The electronic device 20 may be a battery-powered device and may include a battery interface 56 for receiving one or more rechargeable batteries 58. In at least some example embodiments, the battery 58 can be a smart battery with an embedded microprocessor. The battery interface 56 may be coupled to a regulator (not shown), which may assist the battery 58 in providing power V+ to the electronic device 20. Although current technology may make use of a battery, future technologies such as micro fuel cells may provide the power to the electronic device 20.

The electronic device 20 may also include an operating system 60 and software components 62 to 72 which are described in more detail below. The operating system 60 and the software components 62 to 72 that are executed by the main processor 22 are typically stored in a persistent store such as the flash memory 30, which may alternatively be a read-only memory (ROM) or similar storage element (not shown). Those skilled in the art will appreciate that portions of the operating system 60 and the software components 62 to 72, such as specific device applications, or parts thereof, may be temporarily loaded into a volatile store such as the RAM 28. Other software components can also be included, as is well known to those skilled in the art.

The subset of software applications 62 that control basic device operations, including data and voice communication applications, may typically be installed on the electronic device 20 during its manufacture. Other software applications may include a message application 64 that can be any suitable software program that allows a user of the electronic device 20 to send and receive electronic messages. Various alternatives exist for the message application 64 as is well known to those skilled in the art. Messages that have been sent or received by the user are typically stored in the flash memory 30 of the electronic device 20 or some other suitable storage element in the electronic device 20. In at least some example embodiments, some of the sent and received messages may be stored remotely from the device 20 such as in a data store of an associated host system that the electronic device 20 communicates with.

The software applications can further include a device state module 66, a Personal Information Manager (PIM) 68, and other suitable modules (not shown). The device state module 66 may provide persistence, i.e. the device state module 66 ensures that important device data is stored in persistent memory, such as the flash memory 30, so that the data is not lost when the electronic device 20 is turned off or loses power.

The PIM 68 may include functionality for organizing and managing data items of interest to the user, such as, but not limited to, e-mail, contacts, calendar events, voice mails, appointments, and task items. A PIM application may have the ability to send and receive data items via the wireless network 1000. PIM data items may be seamlessly integrated, synchronized, and updated via the wireless network 1000 with the electronic device subscriber's corresponding data items stored and/or associated with a host computer system. This functionality creates a mirrored host computer on the electronic device 20 with respect to such items. This can be particularly advantageous when the host computer system is the electronic device subscriber's office computer system.

The electronic device 20 may also include a connect module 70, and an information technology (IT) policy module 72. The connect module 70 may implement the communication protocols that are required for the electronic device 20 to communicate with the wireless infrastructure and any host system, such as an enterprise system, that the electronic device 20 is authorized to interface with.

The connect module 70 may include a set of APIs that can be integrated with the electronic device 20 to allow the electronic device 20 to use any number of services associated with the enterprise system. The connect module 70 may allow the electronic device 20 to establish an end-to-end secure, authenticated communication pipe with the host system. A subset of applications for which access is provided by the connect module 70 can be used to pass IT policy commands from the host system to the electronic device 20. This can be done in a wireless or wired manner. These instructions can then be passed to the IT policy module 72 to modify the configuration of the device 20. Alternatively, in some cases, the IT policy update can also be done over a wired connection.

Other types of software applications can also be installed on the electronic device 20. These software applications can be third party applications, which are added after the manufacture of the electronic device 20. Examples of third party applications include games, calculators, utilities, etc.

The additional applications can be loaded onto the electronic device 20 through at least one of the wireless network 1000, the auxiliary I/O subsystem 40, the data port 42, the short-range communications subsystem 48, or any other suitable device subsystem 50. This flexibility in application installation may increase the functionality of the electronic device 20 and may provide enhanced on-device functions, communication-related functions, or both. For example, secure communication applications may enable electronic commerce functions and other such financial transactions to be performed using the electronic device 20.

The data port 42 may enable a subscriber to set preferences through an external device or software application and may extend the capabilities of the electronic device 20 by providing for information or software downloads to the electronic device 20 other than through a wireless communication network. The alternate download path may, for example, be used to load an encryption key onto the electronic device 20 through a direct and thus reliable and trusted connection to provide secure device communication.

The data port 42 can be any suitable port that enables data communication between the electronic device 20 and another computing device. The data port 42 can be a serial or a parallel port. In some instances, the data port 42 can be a USB port that includes data lines for data transfer and a supply line that can provide a charging current to charge the battery 58 of the electronic device 20.

The short-range communications subsystem 48 may provide for communication between the electronic device 20 and different systems or devices, without the use of the wireless network 1000. For example, the short-range communications subsystem 48 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download may be processed by the communication subsystem 24 and input to the main processor 22. The main processor 22 may process the received signal for output to the display 32 or alternatively to the auxiliary I/O subsystem 40. A subscriber may also compose data items, such as e-mail messages, for example, using the touch-sensitive overlay 34 on the display 32 that are part of the touch screen display 38, and possibly the auxiliary I/O subsystem 40. The auxiliary I/O subsystem 40 may include devices such as: a mouse, track ball, infrared fingerprint detector, or a roller wheel with dynamic button pressing capability. A composed item may be transmitted over the wireless network 1000 through the communication subsystem 24.

For voice communications, the overall operation of the electronic device 20 may be substantially similar, except that the received signals may be output to the speaker 44, and signals for transmission may be generated by the microphone 46. Alternative voice or audio I/O subsystems, such as a voice message recording subsystem, can also be implemented on the electronic device 20. Although voice or audio signal output may be accomplished primarily through the speaker 44, the display 32 can also be used to provide additional information such as the identity of a calling party, duration of a voice call, or other voice call related information.

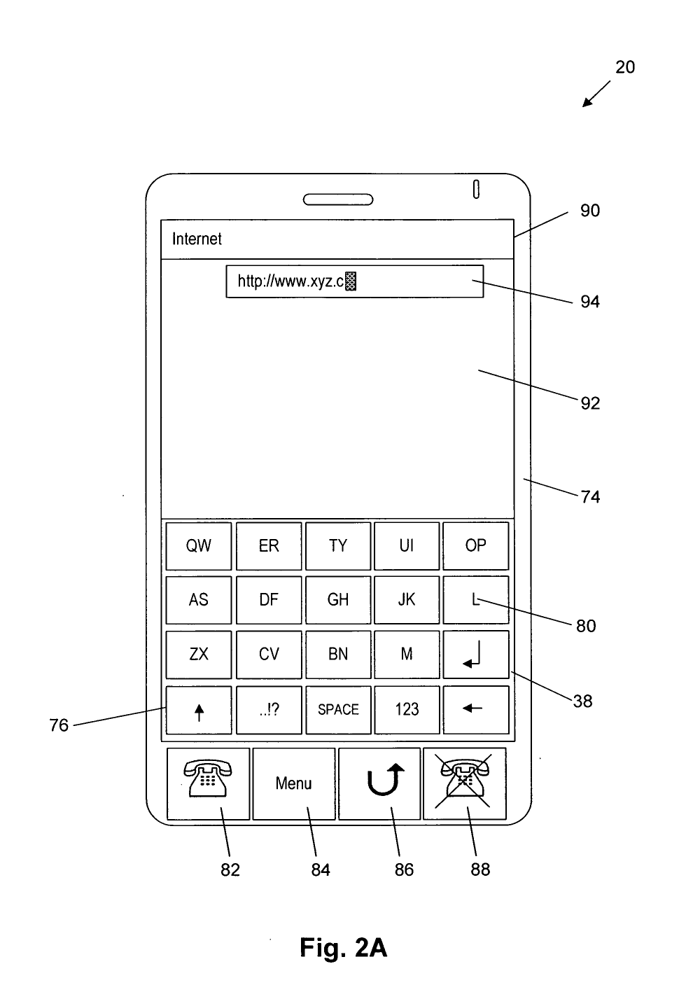

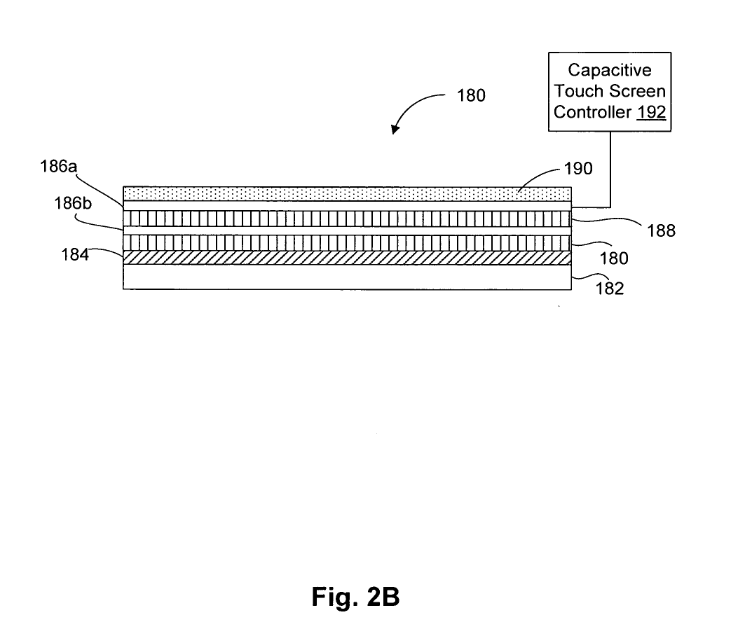

Reference is now made to FIG. 2A, which shows a front view of an example electronic device 20 in portrait orientation. The electronic device 20 may include a housing 74 that houses the internal components that are shown in FIG. 1 and frames the touch screen display or touch-sensitive display 38 such that the touch screen display 38 is exposed for user-interaction therewith when the electronic device 20 is in use. In the example orientation shown in FIG. 2A, the touch screen display 38 may include a portrait mode virtual keyboard 76 for user entry of data in the form of, for example, text during operation of the electronic device 20. It will be appreciated that such a virtual keyboard 76 may be used for data entry in any suitable application such as in an electronic mail application, during electronic mail composition or in any other suitable application. The portrait mode virtual keyboard 76 of FIG. 2A may be provided for data entry in an Internet browser application and is shown as a reduced keyboard for example purposes.

The present disclosure is not limited to the portrait mode virtual keyboard 76 shown, as other keyboards including other reduced keyboards or full keyboards are possible. Suitable keyboards may include full or reduced QWERTY keyboards, full or reduced Dvorak keyboards, and other full or reduced keyboards, including keyboards adapted for non-Roman text input, such as Korean, Chinese or Japanese text input.

The touch screen display 38, in some examples, is any suitable touch screen display such as a capacitive touch screen display. For example, a capacitive touch screen display 38 includes the display device, such as an LCD display 32 and the touch-sensitive overlay 34, in the form of a capacitive touch-sensitive overlay 34, as shown in FIG. 2B. In some example embodiments, the capacitive touch-sensitive overlay 180 includes a number of layers in a stack and is fixed to the input device 142 via a suitable optically clear adhesive. The layers include, for example, a substrate fixed by a suitable adhesive (not shown), a ground shield layer 182, a barrier layer 184, a pair of capacitive touch sensor layers 186a, 186b separated by a substrate or other barrier layer 188, and a cover layer 190 fixed to the outer capacitive touch sensor layer 186a by a suitable adhesive (not shown). The capacitive touch sensor layers are made of any suitable material such as patterned indium tin oxide (ITO).

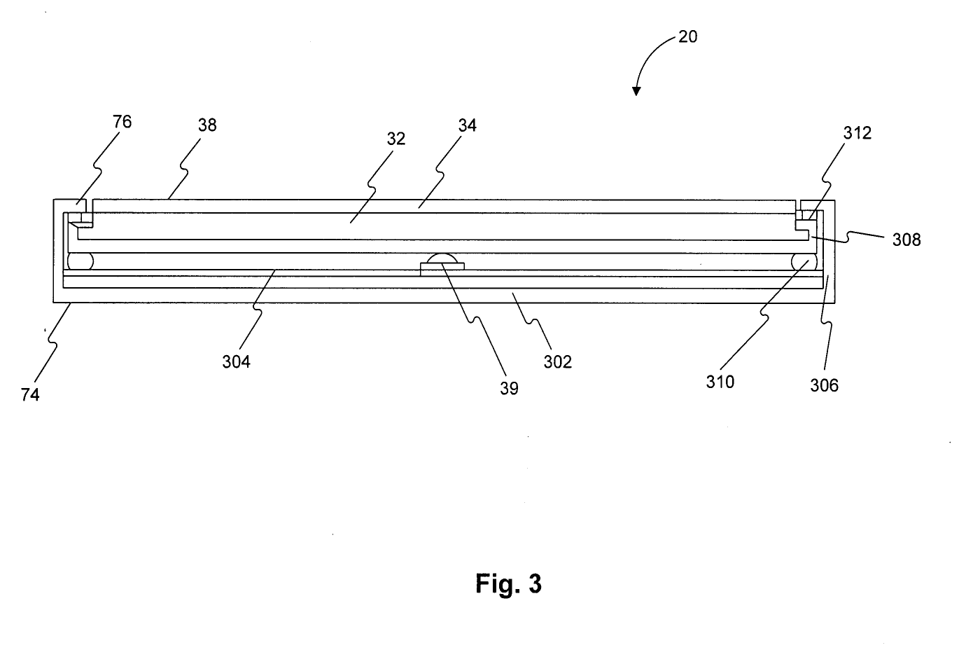

Reference is now made to FIG. 3, showing a simplified sectional side view of the electronic device of FIG. 2A (not to scale), with a switch shown in a rest position. As shown in FIG. 3, the housing 74 may include a back 302, a frame 78, which frames the touch-sensitive display 38, sidewalls 306 that extend between and generally perpendicular to the back 302 and the frame 78, and a base 304 that is spaced from and generally parallel to the back 302. The base 304 can be any suitable base and can include, for example, a printed circuit board or flex circuit board. The back 302 may include a plate (not shown) that is releasably attached for insertion and removal of, for example, the battery 58 and the SIM/RUIM card 52 described above. It will be appreciated that the back 302, the sidewalls 306 and the frame 78 can be injection molded, for example. In the example electronic device 20 shown in FIG. 2A, the frame 78 may be generally rectangular with rounded corners although other shapes are possible.

The display 32 and the touch-sensitive overlay 34 can be supported on a support tray 308 of suitable material such as magnesium for providing mechanical support to the display 32 and touch-sensitive overlay 34. The display 32 and touch-sensitive overlay 34 may be biased away from the base 304, toward the frame 78 by biasing elements 310 such as gel pads between the support tray 308 and the base 304. Compliant spacers 312, which can also be in the form of gel pads for example, may be located between an upper portion of the support tray 308 and the frame 78. The touch screen display 38 may be moveable within the housing 74 as the touch screen display 38 can be moved toward the base 304, thereby compressing the biasing elements 310. The touch screen display 38 can also be pivoted within the housing 74 with one side of the touch screen display 38 moving toward the base 304, thereby compressing the biasing elements 310 on the same side of the touch screen display 38 that moves toward the base 304.

In the present example, the switch 39 may be supported on one side of the base 304 which can be a printed circuit board while the opposing side provides mechanical support and electrical connection for other components (not shown) of the electronic device 20. The switch 39 can be located between the base 304 and the support tray 308. The switch 39, which can be a mechanical dome-type switch, for example, can be located in any suitable position such that displacement of the touch screen display 38 resulting from a user pressing the touch screen display 38 with sufficient force to overcome the bias and to overcome the actuation force for the switch 39, depresses and actuates the switch 39. In the present example embodiment the switch 39 may be in contact with the support tray 308. Thus, depression of the touch screen display 38 by user application of a force thereto, may cause actuation of the switch 39, thereby providing the user with a positive tactile feedback during user interaction with the user interface of the electronic device 20. The switch 39 is not actuated in the rest position shown in FIG. 3, absent applied force by the user. It will be appreciated that the switch 39 can be actuated by pressing anywhere on the touch screen display 38 to cause movement of the touch screen display 38 in the form of movement parallel with the base 304 or pivoting of one side of the touch screen display 38 toward the base 304. The switch 39 may be connected to the processor 22 and can be used for further input to the processor when actuated. Although a single switch is shown any suitable number of switches can be used.

A touch event may be detected upon user touching of the touch screen display 38. Such a touch event can be determined upon a user touch at the touch screen display 38 for selection of, for example, a feature in a list, such as a message or other feature of for scrolling in the list or selecting a virtual input key. Signals may be sent from the touch-sensitive overlay 34 to the controller 36 when a suitable object such as a finger or other conductive object held in the bare hand of a user, is detected. Thus, the touch event may be detected and the X and Y location of the touch may be determined. The X and Y location of the touch may be determined to fall within the touch-sensitive area defined by the boundary on the touch screen display 38.

Reference is again made to FIG. 2B. In the present example, the X and Y locations of a touch event are both determined with the X location determined by a signal generated as a result of capacitive coupling with one of the touch sensor layers 186a, 186b and the Y location determined by the signal generated as a result of capacitive coupling with the other of the touch sensor layers 186a, 186b. In this example, each of the touch-sensor layers 186a, 186b provides a signal to the controller 36 as a result of capacitive coupling with a suitable object such as a finger of a user or a conductive object held in a bare hand of a user resulting in a change in the electric field of each of the touch sensor layers.

In some examples, the outer touch sensor layer 186a is connected to a capacitive touch screen controller 192 in the portable electronic device 20 for conducting a continuous electrical current across the inner touch sensor layer 186b and detecting a change in the capacitance as a result of capacitive coupling between, for example, the finger of a user or a conductive stylus held by a user, and the outer touch sensor layer 186a. Thus, the change in capacitance acts as a signal to the capacitive touch screen controller 192, which senses the touch or near touch, on the touch screen display 38.

When a user places a finger, or other conductive object (e.g., a conductive stylus) on the touch screen display 38 without applying force to cause the two touch sensor layers 186a, 186b to contact each other, capacitive coupling of the finger or conductive object with the outer touch sensor layer 186a occurs, resulting in a signal at the capacitive touch screen controller 192. Capacitive coupling also occurs through the cover layer 190 and through a small air gap. Thus, capacitive coupling occurs, resulting in a signal being sent to the capacitive touch screen controller 192, when the finger or other conductive object (e.g., held in the bare hand of a user) approaches the surface of the cover layer 190 and when contacting the cover layer 190, prior to force being applied to the cover layer 190 to force the two touch sensor layers 186a, 186b into contact with each other. The sensitivity of the capacitive touch screen controller 192 can therefore be set to detect an approaching finger (or other conductive object) at a small distance away from the cover layer 190 of, for example. 9 mm or less. In some examples, the location of approach is not determined, however the approach of a finger or other conductive object that is proximal the outer touch sensor layer 186a is determined. Thus, the outer touch sensor layer 186a and the capacitive touch screen controller 192 act to detect proximity, detecting a finger or conductive object proximal the surface of the cover layer 190.

The signals may represent the respective X and Y touch location values. It will be appreciated that other attributes of the user's touch on the touch screen display 38 can be determined. For example, the size and the shape of the touch on the touch screen display 38 can be determined in addition to the location (e.g., X and Y values) based on the signals received at the controller 36 from the touch sensor layers.

Referring to FIG. 2A, it will be appreciated that a user's touch on the touch screen display 38 may be determined by determining the X and Y touch location and user-selected input may be determined based on the X and Y touch location and the application executed by the processor 22. This determination may be carried out by the processor 22 using one or more software modules 62, including the specific application being executed. In the example screen shown in the front view of FIG. 2A, the application may provide the virtual keyboard 76 having a plurality of virtual input keys or buttons, which can be selected by the user. The user selected virtual input key may be matched to the X and Y touch location. Thus, the button selected by the user may be determined based on the X and Y touch location and the application. In the example shown in FIG. 2A, the user may enter text via the virtual keyboard 76, selecting characters or symbols associated with the virtual input keys, such as alphanumeric characters from the virtual keyboard 76 by touching the touch screen display at the location of the characters, corresponding to the virtual input keys, of the virtual keyboard 76. In example embodiments of the electronic device 20, the text or data entry may be accomplished by a “click to enter” operation. Once the user has selected a character or symbol, the character or symbol may be entered by depressing the virtual input key on the touch screen display 38 with sufficient force to overcome the bias of the touch screen display 38 and the actuation force of the switch 39, to cause movement of the touch screen display 38 and actuation of the switch 39. The selection of the virtual input key 80 (e.g., based on the X and Y location on the touch screen display) and the actuation of the switch 39 may result in signals that may be received by the main processor 22, thereby entering the corresponding character or symbol for rendering on the touch screen display. The “click to enter” operation may provide a tactile feedback confirming the entry to the user, thereby reducing the chance of inadvertent double entry requiring correction. This may also reduce the need for additional user interaction and use time thereby, reducing battery consumption. The click entry may also allow the user to touch the device and ensure the correct character or symbol is selected before entry of that character or symbol by clicking In general, the characters may be alphanumeric characters, although other characters may also be possible, such as characters for non-English languages.

According to the present example as illustrated in FIG. 2A, the main processor 22 may receive a user-selection of an Internet browser application for browsing the Internet by, for example, determination of a touch event at an Internet browser icon (not shown) displayed on the touch screen display 38.

For illustrative purposes, the virtual keyboard 76 may be rendered in the portrait mode as shown in FIG. 2A. Devices, such as accelerometers, can be used to determine the relative orientation of the electronic device 20 and change the orientation of the touch screen display accordingly. The virtual input keys or buttons 80 may be rendered with the alphanumeric characters and other keyboard buttons displayed in an upright position for the user. The electronic device 20 can be operated in any suitable mode for determining a user-desired one of the letters upon determination of a touch event at the respective one of the virtual input keys buttons 80 of the virtual keyboard 76. For example, letters can be selected using a single-tap mode, multi-tap mode, a text prediction mode or using any other suitable mode. The electronic device 20 according to the present example may also include four physical buttons 82, 84, 86, 88 in the housing 74 for user-selection for performing functions or operations including an “off-hook” button 82 for placing an outgoing cellular telephone call or receiving an incoming cellular telephone call, a Menu button 84 for displaying a context-sensitive menu or submenu, an escape button 86 for returning to a previous screen or exiting an application, and an “on-hook” button 88 for ending a cellular telephone call. The remainder of the buttons shown on the face of the example electronic device of FIG. 2A may be virtual buttons or input keys 80 on the touch screen display 38.

Along with the virtual keyboard 76, a display area may be rendered, which in the present example may be a portrait mode display area 90 that is a portrait mode Internet browser display screen 92. The display area may be provided in the portrait mode as a result of determination of the orientation at the accelerometer (not shown). The display area may be rendered above the portrait mode virtual keyboard 76 when the electronic device 20 is in the portrait orientation.

As a result of user touching any of the virtual buttons or input keys 80 of the virtual keyboard 76 and actuation of the switch 39, data input received from the virtual keyboard 76 may be rendered in a data entry field 94 of the Internet browser display screen 92. As shown, input may be received in the form of user selection of characters or symbols by touching the virtual buttons or input keys 80 so as to select the desired character or symbol associated with the virtual button or input key 80 in either the portrait mode or landscape mode, and entry by actuation of the switch 39. In the example shown in FIG. 2A, the user enters “http://www.xyz.c” and the data received may be displayed in the data entry field 94 of the portrait mode Internet browser display screen 92.

When entering data, the user may turn the electronic device 20 to a different orientation to provide a different keyboard layout such as to change from a reduced keyboard layout in the portrait orientation to a full keyboard layout in the landscape orientation, as in the present example. In another example, the user may also choose to turn the electronic device 20 to provide a different display area for the application.

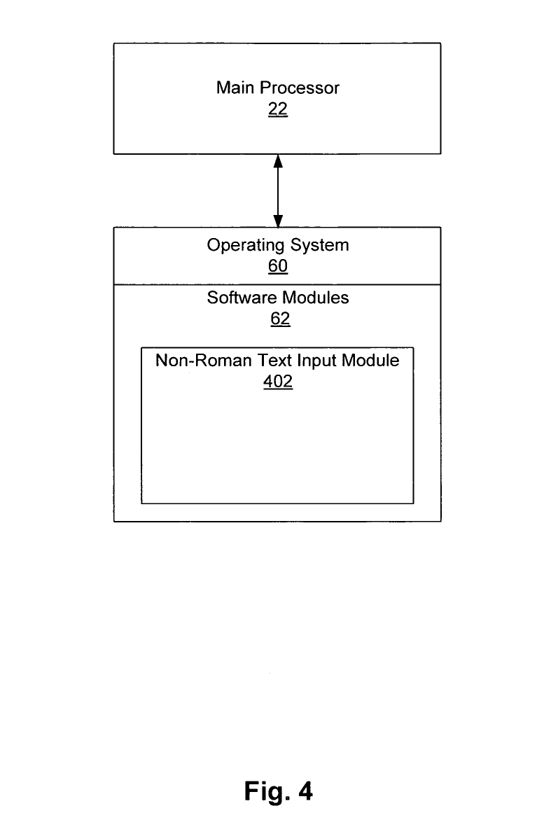

Reference is now made to FIG. 4, which shows a simplified block diagram of an example embodiment of the electronic device 20 suitable for non-Roman text input. This block diagram is similar to that of FIG. 1, but has been simplified for ease of understanding. The main processor 22 may communicate with the operating system 60. The operating system 60 includes software modules 62, as described above. In particular, the software modules 62 includes a non-Roman text input module 402. In other example embodiments, the non-Roman text input module 402 resides in a memory, such as the Random Access Memory (RAM) 28, the flash memory 30 or other subsystems. In the presently described example embodiment, the non-Roman text input module 402 provides a non-Roman text input interface for inputting non-Roman text, such as Korean text, using non-Roman characters, such as Korean characters. The non-Roman text input module 402 is adapted to determine an intended input character or symbol at the virtual keyboard 76. The non-Roman text input module 402 applies one or more rules for determining compound non-Roman characters in a non-Roman language, such as Korean.

The main processor 22 transmits a signal representing an input character at the virtual keyboard 76 to the operating system 60. This signal is received at the non-Roman text input module 402. Where the input character is a non-Roman character, the character is processed according to the one or more rules. For example, the received non-Roman character may be combined with one or more preceding non-Roman characters to form a compound character. The character may be further processed by the main processor 22, including displaying the character on the display 32.

The non-Roman text input module 402 may also be configured to provide an interface for Roman text input. This may be an interface adapted for both non-Roman and Roman text input (e.g., the interface may be a virtual keyboard 76 having virtual keys associated with both Roman and non-Roman characters) or the interface may be switchable between non-Roman and Roman text input (e.g., a virtual keyboard 76 associated with only Roman characters may be switched to one associated with only non-Roman characters, in response to a selection of a switch input, such as selection of a “SWITCH” key).

Thus, the electronic device 20 includes computer executable programmed instructions for directing the electronic device 20 to implement various applications. The programmed instructions may be embodied in the one or more software modules 62 resident in the flash memory 30 of the electronic device 20. Alternatively, the programmed instructions may be embodied in a computer program product having a computer readable medium (such as a DVD, CD, floppy disk or other storage media) with computer executable instructions tangibly recorded thereon, which may be used for transporting the programmed instructions to the flash memory 30 of the electronic device 20. Alternatively, the programmed instructions may be embedded in a computer-readable signal carrying computer readable program instructions that is uploaded to the wireless network 1000 by a vendor or supplier of the programmed instructions, and this signal may be downloaded to the electronic device 20 from, for example, the wireless network 1000 by end users.

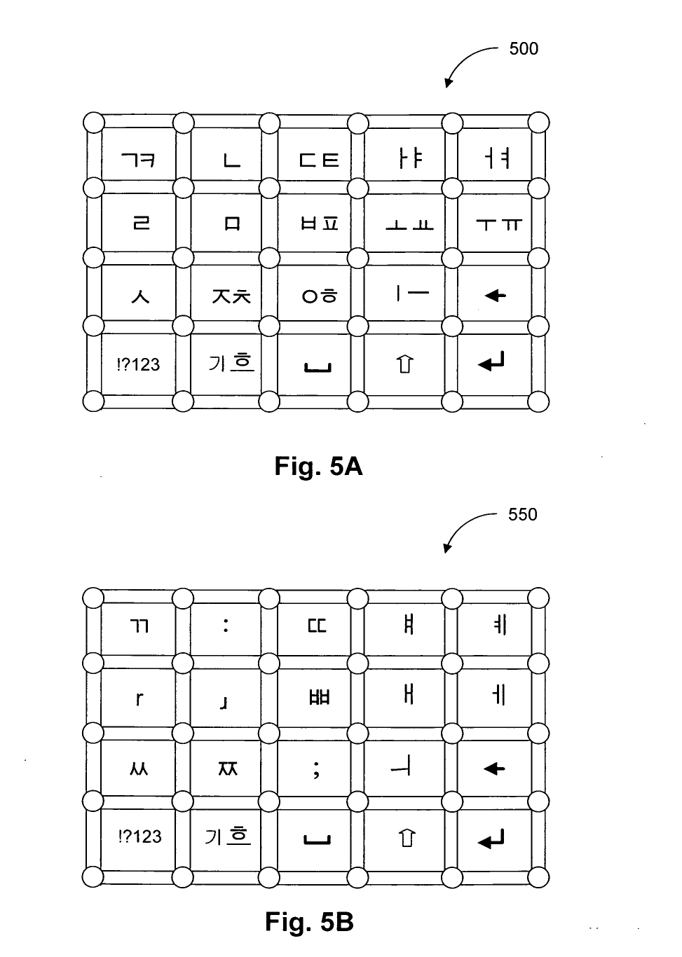

Reference is now made to FIG. 5A, illustrating an example non-Roman text input interface 500 suitable for non-Roman text input. In this example, the non-Roman interface 500 may be suitable for Korean text input, with simple Jamos displayed in association with keys in the interface 500. The interface 500 may be used in a virtual keyboard 76. Alternatively, the non-Roman interface 500 may be implemented as a physical keyboard.

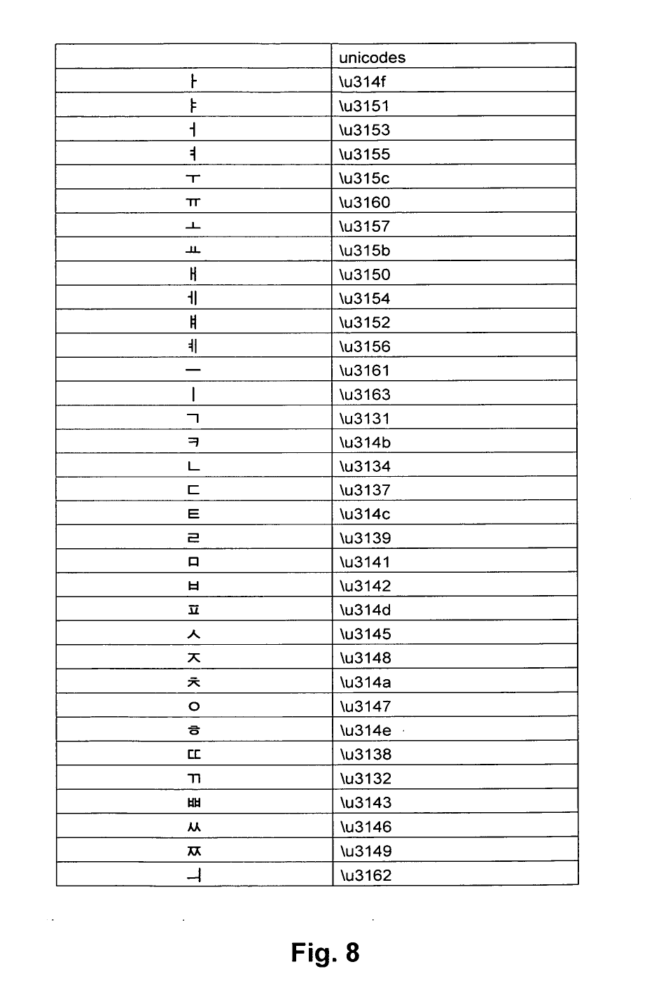

As shown, the interface 500 comprises twenty keys in four rows of five keys each. Other layouts may be suitable, for example having more or less than twenty keys. The interface 500 will be described with reference to the Korean Jamos and unicode as shown in FIG. 8.

The first row comprises five keys: a first key associated with the Jamos having unicodes “\u3131” and “\u314b”; a second key associated with the Jamo having unicode “\u3134”; a third key associated with the Jamos having unicodes “\u3137” and “\u314c”; a fourth key associated with the Jamos having unicodes “\u314f′ and “\u3151”; and a fifth key associated with the Jamos having unicodes “\u3153” and “\u3155”.

The second row comprises five keys: a sixth key associated with the Jamo having unicode “\u3139”; a seventh key associated with the Jamo having unicode “\u3141”; an eighth key associated with the Jamos having unicodes “\u3142” and “\u314d”; a ninth key associated with the Jamos having unicodes “\u3157” and “\u315b”; and a tenth key associated with the Jamos having unicodes “\u315c” and “\u3160”.

The third row comprises five keys: an eleventh key associated with the Jamo having unicode “\u3145”; a twelfth key associated with the Jamos having unicodes “\u3148” and “\u314a”; a thirteenth key associated with the Jamos having unicodes “\u3147” and “\u314e”; a fourteenth key associated with the Jamos having unicodes “\u3163” and “\u3161”; and a fifteenth “BACKSPACE” key.

The fourth row comprises functional or modifier keys. In this example, the fourth row comprises: a sixteenth “!?123” key for toggling punctuation and/or numeric input (e.g., by switching to a punctuation and/or numeric interface); a seventeenth “SYM” key for toggling symbol input (e.g., by switching to an interface for symbols); an eighteenth “Space” key; a nineteenth “SHIFT” key, which may be used for input of characters according to input rules described below (e.g., by switching to non-Roman text input interface 550, shown in FIG. 5B); and a twentieth “ENTER” key.

Reference is now made to FIG. 5B, illustrating an example non-Roman text input interface 550 suitable for non-Roman text input. In this example, the non-Roman interface 550 may be suitable for Korean text input. The interface 550 may be used in a virtual keyboard 76. The interface 550 may be used in conjunction with the interface 500. For example, the interface 550 may be toggled to replace the interface 500 in response to an input to switch the layout, such as a selection of the “SHIFT” key or another non-text input key.

As shown, the interface 550 comprises twenty keys in four rows of five keys each. Other layouts may be suitable, for example having more or less than twenty keys. The interface 550 will be described with reference to the Korean Jamos and unicode as shown in FIG. 8.

The first row comprises five keys: a first key associated with the Jamo having unicode “\u3132”; a second key associated with the symbol “:”; a third key associated with the Jamo having unicode “\u3138”; a fourth key associated with the Jamo having unicode “\3152”; and a fifth key associated with the Jamo having unicode “\u3156”.

The second row comprises five keys: a sixth key associated with a left bracket symbol; a seventh key associated a right bracket symbol; an eighth key associated with the Jamo having unicode “\u3143”; a ninth key associated with the Jamo having unicode “\u3150”; and a tenth key associated with the Jamo having unicode “\u3154”.

The third row comprises five keys: an eleventh key associated with the Jamo having unicode “\u3146”; a twelfth key associated with the Jamo having unicode “\u3149”; a thirteenth key associated with the symbol “;”; a fourteenth key associated with the Jamo having unicode “\u3162”; and a fifteenth “BACKSPACE” key.

The fourth row comprises functional or modifier keys. In this example, the fourth row comprises: a sixteenth “!?123” key for toggling punctuation and/or numeric input (e.g., by switching to a punctuation and/or numeric interface); a seventeenth “SYM” key for toggling symbol input (e.g., by switching to an interface for symbols); an eighteenth “Space” key; a nineteenth “SHIFT” key, which may be used for input of characters according to input rules described below (e.g., by switching to non-Roman text input interface 550, shown in FIG. 5B); and a twentieth “ENTER” key.

In general, the interface 500 and the interface 550 may be designed with the non-Roman characters shown in the layout shown to allow for a relatively efficient entry of non-Roman text, in this example Korean text input. In particular, the layout shown in the interface 500 and the interface 550 may be designed to decrease the number of repeated selections (e.g., double- or triple-click of the same key, or selection of multiple different keys) in order to select a desired character. Each key of the interface 500 and/or the interface 550 may be associated with more than one non-Roman character, and determination of an intended input character may be in accordance with input rules, an example of which is described below.

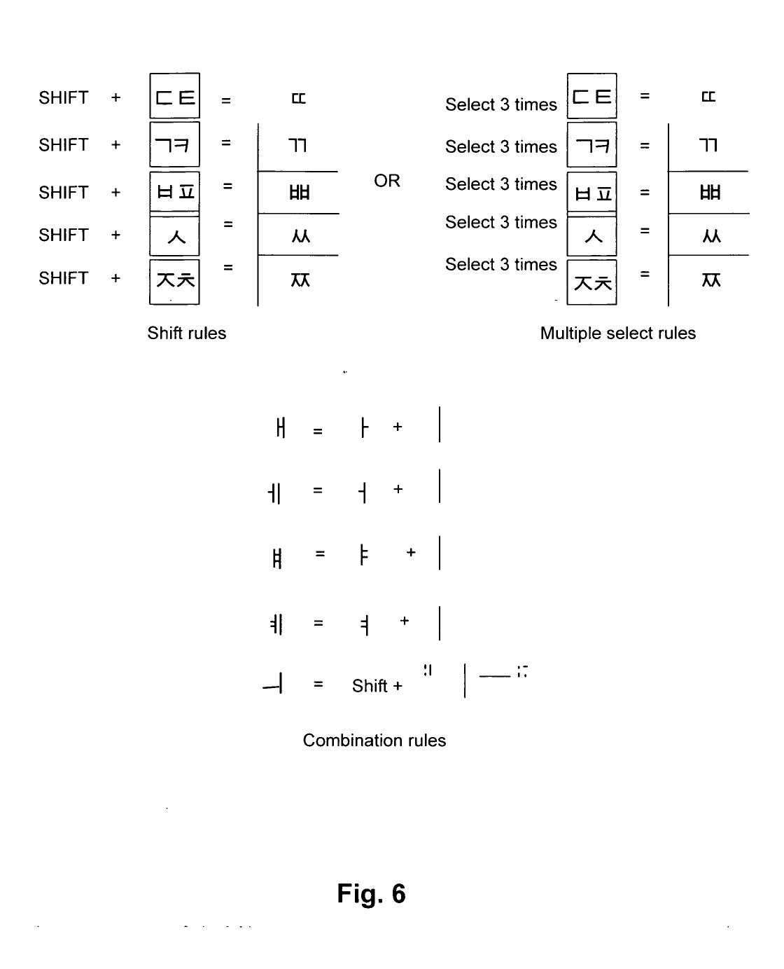

Reference is now made to FIG. 6, illustrating an example set of rules for entry of non-Roman characters. For the purpose of example, the description will refer to the Korean language, comprising Jamo characters, which are syllabic characters used to form complete Hangul characters. There are approximately 40 different Jamos, and it may be cumbersome or confusing to provide separate keys or virtual keys for input of each separate Jamo. For example, in the example interface shown in FIG. 5A, some keys are associated with two different Jamos.

In this example, using the non-Roman text interface, characters may be selected and input using a multi-tap scheme. Specifically, for keys associated with two different characters, the first (e.g., left-most) Korean character may be selected and input by selecting the corresponding key once (e.g., a single click), and the second (e.g., right-most) Korean character may be selected and input by selecting the corresponding key twice within a predetermined time period (e.g., a double-click). For example, when the corresponding key is selected once, the first Korean Jamo character may be entered and displayed, and may be highlighted or underlined until the predetermined time period expires or until a different key is pressed. The highlighting or underlining may indicate the possibility that the key may be selected again to get the second Korean character associated with that key. If the same key is selected again after expiry of the predetermined time period, the first Korean character provided on the key may be inputted twice.

There may additionally be compound Jamos that are not displayed in the interface. These compound Jamos are shown in FIG. 6 with the associated rules for determining their input.

These rules may include a shift rule for determining the compound Jamo based on an inputted Jamo in combination with a preceding non-text input, such as a preceding selection of a functional key, including the “SHIFT” key.

These rules may also include a multiple select rule for determining a compound Jamo character based on two or more selections of the same character within a predetermined time period.

These rules may also include a combination rule for determining a compound Jamo character based on an inputted Jamo in combination with a different preceding Jamo.

In this example, some of the compound Jamos may be inputted by selecting the corresponding key three times within a predetermined time period (e.g., a triple-click) according to the example multiple select rules of FIG. 6. As described above, when the key is selected twice, the second Jamo character may be displayed, and may be highlighted or underlined until the predetermined time period expires or until a different key is pressed. The highlight or underlining may indicate the possibility that the key may be selected a third time to input the corresponding compound Korean Jamo character. If more the predetermined time period expires between the second selection and a third selection, the second Korean character may be entered followed by the first Korean character.

Thus, selecting a key once selects a first Jamo, selecting the same key again in a predetermined time period selects a second Jamo, and selecting the same key a third time within the predetermined time period selects a compound Jamo that is not displayed in the interface, in accordance with the multiple select rules.

In some examples, a Jamo selectable by selection of the same key three times may also be selected by a selection of a function or modifier key, in accordance with the example shift rules of FIG. 6. For example, selection of a non-text input key, for example a function key such as the “SHIFT” key, followed by a character key associated with a compound Jamo, may result in the input of the compound Jamo. This may be useful in reducing the amount of input and input time required for the entry of a compound Jamo. In some examples, selection of the “SHIFT” key may switch the interface to display the compound characters selectable using the shift rules, such as the interface 550 shown in FIG. 5B.

Some compound Jamos may be inputted by combining two simple Jamos, for example as shown in the combination rules of FIG. 6. According to these rules, a first and a second different Jamo may be selected in succession, within a predetermined time period, to input a compound Jamo. In this example, the use of these combination rules may be distinguished from an input of two simple Jamos in succession on the basis that the particular character and input combinations are not known to produce any valid Korean character. In some examples, a compound Jamo determined according to the combination rules may not be determined according to the multiple select rules or the shift rules.

The interface layout and input rules described above may allow for completion of a Hangul character, without any explicit input (e.g., a selection of “ENTER” or a selection of “NEXT WORD” keys) to indicate the completion of the Hangul. For example, in the Korean language, there may be certain grammatical rules governing the formation of Hangul characters. For example, it may be known that no valid Hangul contains two certain Jamos in succession. Thus, the entry of these two Jamos in succession would be determined to indicate the end of one Hangul and the beginning of the next Hangul.

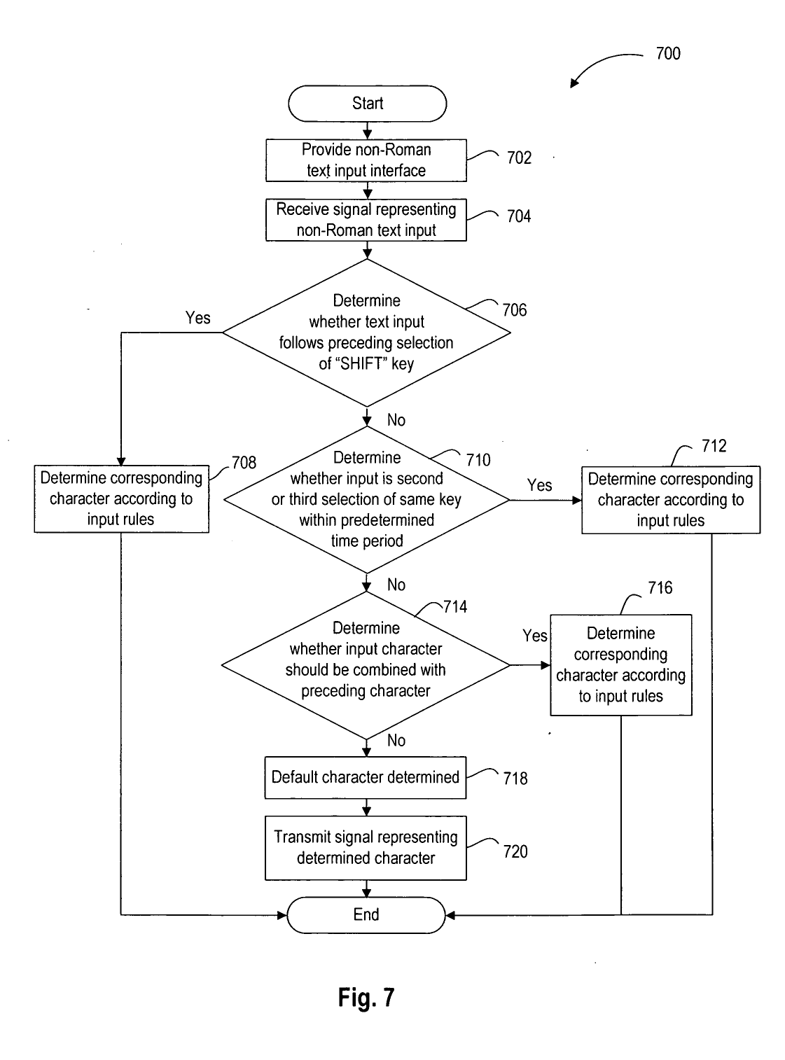

Reference is now made to FIG. 7, illustrating an example method 700 for non-Roman text input.

At 702, a non-Roman text input interface is provided. For example, the non-Roman interface may be provided by the non-Roman text input module 402 for display on an output device, such as the display 32. As described above, the non-Roman interface may be adapted for input of Korean text, and may be adapted for application of the input rules described above.

At 704, a signal representing a non-Roman text input, for example in response to an input using the non-Roman interface, is received. For example, a signal may be received at the non-Roman text input module 402 in response to an input using the virtual keyboard 76 having the non-Roman interface. The non-Roman text input may be a non-Roman character, such as a Korean character.

At 706, it is determined whether the non-Roman text input follows a preceding selection of a “SHIFT” key. Although a “SHIFT” key is described, some other functional or modifier key may be used. Determination of whether there was a preceding selection of the “SHIFT” key may be determined at the non-Roman text input module 402, for example by determining whether a flag was set.

If so, then at 708, a compound character corresponding to the combination of the “SHIFT” key and the input is determined. This may be performed at the non-Roman text input module 402, according to one or more input rules described above, such as the shift rules. The method 700 proceeds to 720.

If not, then at 710, it is determined whether the input is a second or third selection of the same key within a predetermined time period.

If so (i.e. if it is determined that the input is a second or third selection of the same key within the predetermined time period), then at 712, the respective second character or compound character is determined, for example at the non-Roman text input module 402, and a signal representing the determined character is transmitted, for example for display on the display 32. This determination may be according to one or more input rules described above, such as the multiple select rules. The method 700 proceeds to 720.

If not (i.e. if it is determined that the input is not a second or third selection of the same key within the predetermined time period), then at 714, it is determined whether the character selected by the input should be combined with a preceding character to form a compound character. This determination may be performed by the non-Roman text input module 402, according to one or more input rules described above, such as the combination rules.

If so (i.e. if it is determined that the character selected by the input should be combined with a preceding character to form a compound character), then at 716 the corresponding compound character is determined. The method 700 proceeds to 720.

If not (i.e. if it is determined that the character selected by the input should not be combined with a preceding character to form a compound character), then at 714 none of the input rules are to be followed, and the default simple character (e.g., the first or left-most character for the corresponding key shown in the interface) corresponding to the input is determined.

At 720, a signal representing the determined character is transmitted, for example for display on the display 32. The method 700 ends.

Although the method 700 is described as applying multiple select rules, combination rules and shift rules, the method 700 need not apply all three types of rules, and may apply only one or only two types of rules. The method 700 may, for example, apply the input rules described with reference to FIG. 6.

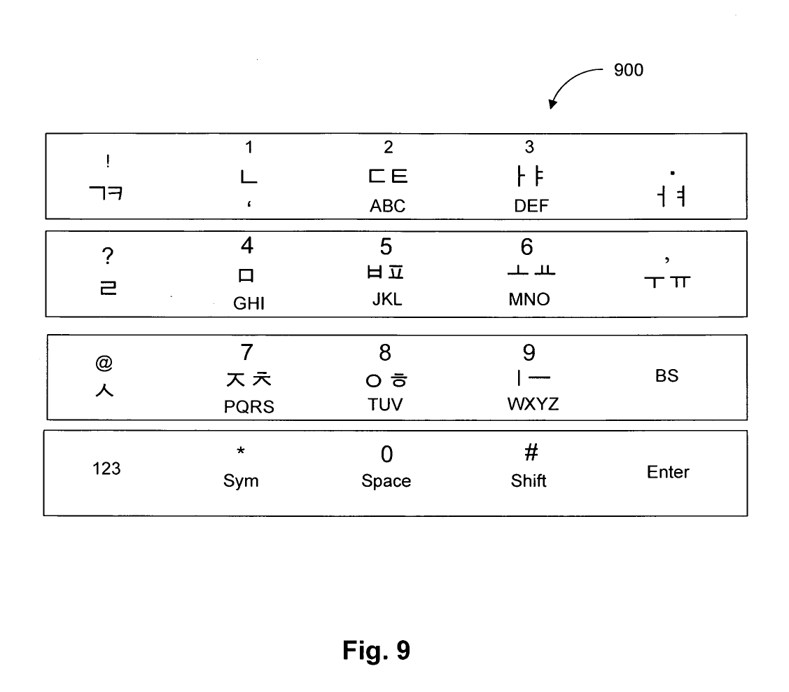

Reference is now made to FIG. 9, illustrating an example interface 900 for non-Roman text input in accordance with an example embodiment. The interface 900 is adapted for both non-Roman text input and Roman text input. Each key in the interface 900 may be associated with one or more of a non-Roman character, a Roman character, a numeric character, a symbol, or a function or modifier key. The interface 900 may be used in the virtual keyboard 76, and may be provided for interface through the display 32.

As shown, the interface 900 comprises twenty keys in four rows of five keys each. Other layouts may be suitable, for example having more or less than twenty keys. The interface 900 will be described with reference to the Korean Jamos and unicode as shown in FIG. 8.

The first row comprises five keys: a first key associated with the Jamos having unicodes “\u3131” and “\u314b”, and the symbol “!”; a second key associated with the Jamo having unicode “\u3134”, the number “1” and the symbol “'”; a third key associated with the Jamos having unicodes “\u3137” and “\u314c”, the number “2” and the Roman characters “ABC”; a fourth key associated with the Jamos having unicodes “\u314f” and “\u3151”, the number “3” and the Roman characters “DEF”; and a fifth key associated with the Jamos having unicodes “\u3153” and “\u3155” and the symbol “.”.

The second row comprises five keys: a sixth key associated with the Jamo having unicode “\u3139” and the symbol “?”; a seventh key associated with the Jamo having unicode “\u3141”, the number “4” and the Roman characters “GHI”; an eighth key associated with the Jamos having unicodes “\u3142” and “\u314d”, the number “5” and the Roman characters “JKL”; a ninth key associated with the Jamos having unicodes “\u3157” and “\u315b”, the number “6” and the Roman characters “MNO”; and a tenth key associated with the Jamos having unicodes “\u315c” and “\u3160”, and the symbol “,”.

The third row comprises five keys: an eleventh key associated with the Jamo having unicode “\u3145” and the symbol “@”; a twelfth key associated with the Jamos having unicodes “\u3148” and “\u314a”, the number “7” and the Roman characters “PQRS”; a thirteenth key associated with the Jamos having unicodes “\u3147” and “\u314e”, the number “8” and the Roman characters “TUV”; a fourteenth key associated with the Jamos having unicodes “\u3163” and “\u3161”, the number “9” and the Roman characters “WXYZ”; and a fifteenth “BACKSPACE” key.

The fourth row comprises functional or modifier keys. In this example, the fourth row comprises: a sixteenth “123” key for toggling punctuation and/or numeric input (e.g., by switching to a punctuation and/or numeric interface); a seventeenth “SYM” key for toggling symbol input (e.g., by switching to an interface for symbols), which is also associated with the symbol “*”; an eighteenth “Space” key, which is also associated with the number “0”; a nineteenth “SHIFT” key, which may be used for input of characters according to input rules described below (e.g., by switching to non-Roman text input interface 550, shown in FIG. 5B), and which is also associated with the symbol “#”; and a twentieth “ENTER” key.

Although certain symbols, numeric characters and Roman characters are described as being associated with certain keys and non-Roman characters in the example interface 900, different symbols, numeric characters and Roman characters may be associated with different keys in different orders. In general, any order and combination of symbols, numeric characters and Roman characters may be associated with any of the keys shown in the interface 500 and the interface 550.

It will be appreciated that the process shown and described with reference to FIG. 7 is simplified for the purpose of the present explanation and other steps and substeps may be included. Alternatively, some of the steps and substeps may be excluded or may be performed in an order different from the order in which they are described without materially affecting the end results of the method 700. Although the method 700 is described as taking place at the non-Roman text input module 402, a person skilled in the art would understand that a module or modules similar to the non-Roman text input module 402 may be implemented as part of the other software modules on the electronic device 20. The steps described may be carried out by a single module or may be carried out by several different modules.

In the following description, for purposes of explanation, numerous details are set forth in order to provide a thorough understanding of the present disclosure. However, it will be apparent to one skilled in the art that these specific details are not required in order to practice the present disclosure. In other instances, well-known electrical structures and circuits are shown in block diagram form in order not to obscure the present disclosure. For example, specific details are not provided as to whether the example embodiments of the disclosure are implemented as a software routine, hardware circuit, firmware, or a combination thereof.

Example embodiments of the present disclosure may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an example embodiment of the present disclosure. Those of ordinary skill in the art will appreciate that other instructions and operations necessary to implement the present disclosure may also be stored on the machine-readable medium. Software running from the machine-readable medium may interface with circuitry to perform the described tasks.

The present disclosure is also directed to an apparatus for carrying out the disclosed method, including apparatus parts for performing each described step, be it by way of hardware components, a computer programmed by appropriate software to enable the practice of the disclosed method, by any combination of the two, or in any other manner. Moreover, in some example embodiments, an article of manufacture for use with the apparatus, such as a pre-recorded storage device or other similar computer readable medium having program instructions tangibly recorded thereon, or a computer data signal carrying computer readable program instructions may also direct an apparatus to facilitate the practice of the disclosed method. It would be understood that such apparatus, articles of manufacture, and computer data signals also come within the scope of the present disclosure.

While the example embodiments described herein are directed to particular implementations of the electronic device and the method of controlling the electronic device, it will be understood that modifications and variations may occur to those skilled in the art. All such modifications and variations, including all suitable current and future changes in technology, are believed to be within the sphere and scope of the present disclosure. All references mentioned are hereby incorporated in their entirety by reference.

1. An electronic device for non-Roman text input, the device comprising:
a microprocessor for controlling the operation of the wireless device;
an input device coupled to the microprocessor for accepting an input;
an output device coupled to the microprocessor for communicating an output; and
a memory coupled to the microprocessor;
the wireless device including a non-Roman text input module resident in the memory for execution by the microprocessor, the non-Roman text input module being configured to:
provide a non-Roman text input interface for display on the output device, the interface being adapted for non-Roman text input in a first language;
receive a signal representing a non-Roman text input in response to an input using the interface;
determine a non-Roman character corresponding to the non-Roman text input, the non-Roman character being determined according to one or more rules for determining a compound non-Roman character based on the non-Roman text input in combination with a preceding input; and
transmit a signal representing the determined non-Roman character for display on the output device.

2. The device of claim 1, wherein the one or more rules include at least one of:
a combination rule for determining the compound non-Roman character based on the non-Roman text input in combination with a different preceding non-Roman character;
a shift rule for determining the compound non-Roman character based on the non-Roman text input in combination with a preceding non-text input; and
a multiple select rule for determining the compound non-Roman character based on two or more selections of a same non-Roman text input within a predetermined time period.

3. The device of claim 1, wherein the interface is also adapted for Roman text input.

4. The device of claim 1, wherein the input device is a touchscreen device and the interface is a virtual keyboard interface.

5. The device of claim 1, wherein the first non-Roman character and the preceding non-Roman character are the same character.

6. The device of claim 1, wherein the first non-Roman character and the preceding non-Roman character are different characters.

7. The device of claim 1, wherein the compound character is based on the first non-Roman character and two or more preceding non-Roman characters.

8. The device of claim 1, wherein the non-Roman characters are Korean characters.

9. The device of claim 1, wherein the non-Roman text input module is further configured to:
accept a signal representing an instruction to switch to a Roman text input; and
in response to the instruction to switch to a Roman text input, provide a Roman text input interface adapted for Roman text input in a second language;

10. The device of claim 9, wherein the non-Roman interface comprises a non-text key for switching to a compound non-Roman interface for inputting compound non-Roman characters, the compound non-Roman interface comprising:
a first compound key associated with a non-Roman character having unicode “\u3132”;
a second compound key associated with the symbol “:”;
a third compound key associated with a non-Roman character having unicode “\u3138”;
a fourth compound key associated with a non-Roman character having unicode “\3152”;
a fifth compound key associated with a non-Roman character having unicode “\u3156”.
a sixth compound key associated with a left bracket symbol;
a seventh compound key associated a right bracket symbol;
an eighth compound key associated with a non-Roman character having unicode “\u3143”;
a ninth compound key associated with a non-Roman character having unicode “\u3150”;
a tenth compound key associated with a non-Roman character having unicode “\u3154”;
an eleventh compound key associated with a non-Roman character having unicode “\u3146”;
a twelfth compound key associated with a non-Roman character having unicode “\u3149”;
a thirteenth compound key associated with the symbol “;”; and
a fourteenth compound key associated with a non-Roman character having unicode “\u3162”.

11. The device of claim 1, wherein the non-Roman interface comprises:
a first key associated with non-Roman characters having unicodes “\u3131” and “\u314b”;
a second key associated with a non-Roman character having unicode “\u3134”;
a third key associated with non-Roman characters having unicodes “\u3137” and “\u314c”;
a fourth key associated with non-Roman characters having unicodes “\u314f” and “\u3151”;
a fifth key associated with non-Roman characters having unicodes “\u3153” and “\u3155”;
a sixth key associated with a non-Roman character having unicode “\u3139”;
a seventh key associated with a non-Roman character having unicode “\u3141”;
an eighth key associated with non-Roman characters having unicodes “\u3142” and “\u314d”;
a ninth key associated with non-Roman characters having unicodes “\u3157” and “\u315b”;
a tenth key associated with non-Roman characters having unicodes “\u315c” and “\u3160”;
an eleventh key associated with a non-Roman character having unicode “\u3145”;
a twelfth key associated with non-Roman characters having unicodes “\u3148” and “\u314a”;
a thirteenth key associated with non-Roman characters having unicodes “\u3147” and “\u314e”;
and a fourteenth key associated with non-Roman characters having unicodes “\u3163” and “\u3161”.

12. A method for non-Roman text input comprising:
providing a non-Roman text input interface, the interface being adapted for non-Roman text input in a first language;
receiving a signal representing a non-Roman text input in response to an input using the interface;
determining a non-Roman character corresponding to the non-Roman text input, the non-Roman character being determined according to one or more rules for determining a compound non-Roman character based on the non-Roman text input in combination with a preceding input; and
transmitting a signal representing the determined non-Roman character for display on the output device.

13. The method of claim 12, wherein the one or more rules include at least one of:
a combination rule for determining the compound non-Roman character based on the non-Roman text input in combination with a different preceding non-Roman character;
a shift rule for determining the compound non-Roman character based on the non-Roman text input in combination with a preceding non-text input; and
a multiple select rule for determining the compound non-Roman character based on two or more selections of a same non-Roman text input within a predetermined time period.

14. The method of claim 12, wherein the interface is also adapted for Roman text input.

15. The method of claim 12, wherein the first non-Roman character and the preceding non-Roman character are the same character.

16. The method of claim 12, wherein the first non-Roman character and the preceding non-Roman character are different characters.

17. The method of claim 12, wherein the compound character is based on the first non-Roman character and two or more preceding non-Roman characters.

18. The method of claim 12, wherein the non-Roman characters are Korean characters.

19. The method of claim 12, further comprising:
accepting a signal representing an instruction to switch to a Roman text input; and
in response to the instruction to switch to a Roman text input, providing a Roman text input interface adapted for Roman text input in a second language;

20. The method of claim 19, wherein the non-Roman interface comprises a non-text key for switching to a compound non-Roman interface for inputting compound non-Roman characters, the compound non-Roman interface comprising:
a first compound key associated with a non-Roman character having unicode “\u3132”;
a second compound key associated with the symbol “:”;
a third compound key associated with a non-Roman character having unicode “\u3138”;
a fourth compound key associated with a non-Roman character having unicode “\3152”;
a fifth compound key associated with a non-Roman character having unicode “\u3156”.
a sixth compound key associated with a left bracket symbol;
a seventh compound key associated a right bracket symbol;
an eighth compound key associated with a non-Roman character having unicode “\u3143”;
a ninth compound key associated with a non-Roman character having unicode “\u3150”;
a tenth compound key associated with a non-Roman character having unicode “\u3154”;
an eleventh compound key associated with a non-Roman character having unicode “\u3146”;
a twelfth compound key associated with a non-Roman character having unicode “\u3149”;
a thirteenth compound key associated with the symbol “;”; and
a fourteenth compound key associated with a non-Roman character having unicode “\u3162”.

21. The method of claim 12, wherein the non-Roman interface comprises:
a first key associated with non-Roman characters having unicodes “\u3131” and “\u314b”;
a second key associated with a non-Roman character having unicode “\u3134”;
a third key associated with non-Roman characters having unicodes “\u3137” and “\u314c”;
a fourth key associated with non-Roman characters having unicodes “\u314f” and “\u3151”;
a fifth key associated with non-Roman characters having unicodes “\u3153” and “\u3155”;
a sixth key associated with a non-Roman character having unicode “\u3139”;
a seventh key associated with a non-Roman character having unicode “\u3141”;
an eighth key associated with non-Roman characters having unicodes “\u3142” and “\u314d”;
a ninth key associated with non-Roman characters having unicodes “\u3157” and “\u315b”;
a tenth key associated with non-Roman characters having unicodes “\u315c” and “\u3160”;
an eleventh key associated with a non-Roman character having unicode “\u3145”;
a twelfth key associated with non-Roman characters having unicodes “\u3148” and “\u314a”;
a thirteenth key associated with non-Roman characters having unicodes “\u3147” and “\u314e”;
and a fourteenth key associated with non-Roman characters having unicodes “\u3163” and “\u3161”.

22. A machine readable medium having executable instructions tangibly recorded thereon, the instructions comprising:
code for providing a non-Roman text input interface, the interface being adapted for non-Roman text input in a first language;
code for receiving a signal representing a non-Roman text input in response to an input using the interface;
code for determining a non-Roman character corresponding to the non-Roman text input, the non-Roman character being determined according to one or more rules for determining a compound non-Roman character based on the non-Roman text input in combination with a preceding input; and
code for transmitting a signal representing the determined non-Roman character for display on the output device.

23. The machine readable medium of claim 22, wherein the one or more rules include at least one of:
a combination rule for determining the compound non-Roman character based on the non-Roman text input in combination with a different preceding non-Roman character;
a shift rule for determining the compound non-Roman character based on the non-Roman text input in combination with a preceding non-text input; and
a multiple select rule for determining the compound non-Roman character based on two or more selections of a same non-Roman text input within a predetermined time period.

24. The machine readable medium of claim 22, wherein the interface is also adapted for Roman text input.

25. The machine readable medium of claim 22, wherein the first non-Roman character and the preceding non-Roman character are the same character.

26. The machine readable medium of claim 22, wherein the first non-Roman character and the preceding non-Roman character are different characters.

27. The machine readable medium of claim 22, wherein the compound character is based on the first non-Roman character and two or more preceding non-Roman characters.

28. The machine readable medium of claim 22, wherein the non-Roman characters are Korean characters.

29. The machine readable medium of claim 22, the instructions further comprise:
code for accepting a signal representing an instruction to switch to a Roman text input; and
code for, in response to the instruction to switch to a Roman text input, providing a Roman text input interface adapted for Roman text input in a second language;

30. The machine readable medium of claim 29, wherein the non-Roman interface comprises a non-text key for switching to a compound non-Roman interface for inputting compound non-Roman characters, the compound non-Roman interface comprising:
a first compound key associated with a non-Roman character having unicode “\u3132”;
a second compound key associated with the symbol “:”;
a third compound key associated with a non-Roman character having unicode “\u3138”;
a fourth compound key associated with a non-Roman character having unicode “\3152”;
a fifth compound key associated with a non-Roman character having unicode “\u3156”.
a sixth compound key associated with a left bracket symbol;
a seventh compound key associated a right bracket symbol;
an eighth compound key associated with a non-Roman character having unicode “\u3143”;
a ninth compound key associated with a non-Roman character having unicode “\u3150”;
a tenth compound key associated with a non-Roman character having unicode “\u3154”;
an eleventh compound key associated with a non-Roman character having unicode “\u3146”;
a twelfth compound key associated with a non-Roman character having unicode “\u3149”;
a thirteenth compound key associated with the symbol “;”; and
a fourteenth compound key associated with a non-Roman character having unicode “\u3162”.

31. The machine readable medium of claim 22, wherein the non-Roman interface comprises:
a first key associated with non-Roman characters having unicodes “\u3131” and “\u314b”;
a second key associated with a non-Roman character having unicode “\u3134”;
a third key associated with non-Roman characters having unicodes “\u3137” and “\u314c”;
a fourth key associated with non-Roman characters having unicodes “\u314f” and “\u3151”;
a fifth key associated with non-Roman characters having unicodes “\u3153” and “\u3155”;
a sixth key associated with a non-Roman character having unicode “\u3139”;
a seventh key associated with a non-Roman character having unicode “\u3141”;
an eighth key associated with non-Roman characters having unicodes “\u3142” and “\u314d”;
a ninth key associated with non-Roman characters having unicodes “\u3157” and “\u315b”;
a tenth key associated with non-Roman characters having unicodes “\u315c” and “\u3160”;
an eleventh key associated with a non-Roman character having unicode “\u3145”;
a twelfth key associated with non-Roman characters having unicodes “\u3148” and “\u314a”;
a thirteenth key associated with non-Roman characters having unicodes “\u3147” and “\u314e”;
and a fourteenth key associated with non-Roman characters having unicodes “\u3163” and “\u3161”.
